(19) United States
(12) Patent Application Publication
(10) Pub. No.: US 2025/0054142 A1
(43) Pub. Date: Feb. 13, 2025

(54) METHOD AND APPARATUS FOR ANALYZING PATHOLOGICAL SLIDE IMAGE

(71) Applicant: Lunit Inc., Seoul (KR)

(72) Inventors: Suk Jun KIM, Seoul (KR); Heon Song, Seoul (KR); Won Kyung Jung, Seoul (KR); Soo lck Cho, Seoul (KR)

(73) Assignee: Lunit Inc., Seoul (KR)

(21) Appl. No.: 18/799,341

(22) Filed: Aug. 9, 2024

(30) Foreign Application Priority Data
Aug. 11, 2023 (KR) 10-2023-0105336
Dec. 19, 2023 (KR) 10-2023-0185499
Jun. 10, 2024 (KR) 10-2024-0075205
Aug. 8, 2024 (KR) 10-2024-0106457

(51) Int. Cl. G06T 7/00

(52) U.S. Cl. CPC G06T 7/0012; G06T 2207/10024; G06T 2207/20084; G06T 2207/30024

(57) ABSTRACT

A computing device includes at least one memory and at least one processor. The at least one processor is configured to detect a plurality of tumor cells included in one or more tumor areas (cancer areas) from a pathological slide image, determine a cell expression class of the plurality of tumor cells, based on a biomarker expression degree of the plurality of tumor cells, and generate a heatmap image for the pathological slide image, based on a result of the determining.

### CROSS-REFERENCE TO RELATED APPLICATIONS

This application is based on and claims priority under 35 USC § 119 to Korean Patent Application Nos. 10-2023-0105336, filed on Aug. 11, 2023, 10-2023-0185499, filed on Dec. 19, 2023, 10-2024-0075205, filed on Jun. 10, 2024, and 10-2024-0106457, filed on Aug. 8, 2024 in the Korean Intellectual Property Office, the disclosures of which are incorporated by reference herein in their entirety.

### BACKGROUND

### 1. Field

The disclosure relates to a method and apparatus for analyzing a pathological slide image.

### 2. Description of the Related Art

The field of digital pathology is a field that obtains histological information or predicts the prognosis of patients by using a whole slide image (WSI) generated by scanning pathological slide images.

Recently, technologies for predicting medical information by analyzing a pathological slide image through an artificial intelligence (AI) model have been developed. However, there is a need for a method of analyzing a pathological slide image so as to increase accuracy and speed in predicting medical information.

### SUMMARY

The disclosure provides a method and apparatus for analyzing a pathological slide image. In addition, the disclosure provides a computer-readable recording medium having recorded thereon a program for causing a computer to perform the method. The technical problems to be solved by the disclosure are not limited to those described above, and other technical problems may be present.

Additional aspects will be set forth in part in the description which follows and, in part, will be apparent from the description, or may be learned by practice of the presented embodiments of the disclosure.

A computing device according to an aspect includes at least one memory and at least one processor, wherein the at least one processor is configured to detect a plurality of tumor cells included in one or more tumor areas (cancer areas) from a pathological slide image, determine a cell expression class of the plurality of tumor cells, based on a biomarker expression degree of the plurality of tumor cells, and generate a heatmap image for the pathological slide image, based on a result of the determining.

A method of analyzing a pathological slide image, according to another aspect, includes detecting a plurality of tumor cells included in one or more tumor areas from a pathological slide image, determining a cell expression class of the plurality of tumor cells, based on a biomarker expression degree of the plurality of tumor cells, and generating a heatmap image for the pathological slide image, based on a result of the determining.

A computer-readable recording medium according to another aspect includes a recording medium having recorded thereon a program for causing a computer to perform the method described above.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing an example of a system for analyzing a pathological slide image, according to an embodiment;

FIG. 2A is a configuration diagram illustrating an example of a user terminal according to an embodiment;

FIG. 2B is a configuration diagram illustrating an example of a server according to an embodiment;

FIG. 3 is a flowchart for describing an example of a method of analyzing a pathological slide image, according to an embodiment;

FIG. 4 is a diagram for describing an example of detecting tumor cells from a pathological slide image, according to an embodiment;

FIG. 5 is a diagram illustrating tumor areas and tumor cells according to an embodiment;

FIG. 6 is a diagram for describing a method of classifying a plurality of tumor cells, according to an embodiment of the disclosure;

FIG. 7 is a diagram for describing a method of classifying a pathological slide image, according to an embodiment of the disclosure;

FIG. 8 is a diagram illustrating an example of pathological slide images respectively corresponding to magnifications, according to an embodiment of the disclosure;

FIG. 9 is a diagram for describing a method of generating a plurality of layers, according to an embodiment of the disclosure;

FIG. 10 is a diagram for describing a method of generating a heatmap image, according to an embodiment of the disclosure;

FIG. 11 is a diagram illustrating an example of a pathological slide image according to an embodiment of the disclosure;

FIG. 12 is a diagram for describing a first tumor area and a second tumor area according to an embodiment of the disclosure;

FIGS. 13 and 14 are diagrams illustrating an example of pathological slide images of a first tumor area and a second tumor area, according to an embodiment of the disclosure;

FIGS. 15 to 18 are diagrams illustrating an example of pathological slide images corresponding to user input, according to an embodiment of the disclosure; and

FIG. 19 is a diagram for describing another example of a system for analyzing a pathological slide image.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As for the terms as used in embodiments, common terms that are currently widely used are selected as much as possible. However, the terms may vary depending on the intention of those of ordinary skill in the art, precedents, the emergence of new technology, and the like. Also, in particular cases, there are also terms arbitrarily selected by the applicant. In such cases, the meaning of the terms will be described in detail in the description of the disclosure. Therefore, terms used in the specification should be defined based on the meaning of the terms and the overall description of the specification, not just the names of the terms.

Throughout the specification, the expression “a portion includes a certain element” means that the portion further includes other elements rather than excludes other elements unless otherwise stated. Also, the terms such as “unit” and “module” described in the specification mean units that process at least one function or operation, and may be implemented as hardware, software, or a combination of hardware and software.

It will be understood that although the terms including ordinal numbers, such as “first” or “second,” may be used to describe various elements, these elements should not be limited by these terms. These terms may be only used to distinguish one element from another.

According to an embodiment, a “pathological slide image” may refer to an image of a pathological slide in which tissue removed from the human body has been fixed and stained through a series of chemical treatments. In addition, the pathological slide image may refer to a whole slide image (WSI) including a high-resolution image of a whole slide and may refer to a portion of the WSI, for example, one or more patches. For example, the pathological slide image may refer to a digital image captured or scanned by a scanning device (e.g., a digital scanner, etc.) and may include information about specific proteins, cells, tissue, and/or structures in the human body. In addition, the pathological slide image may include one or more patches, and medical information including histological information may be applied (e.g., tagged) to the one or more patches through an annotation process. Hereinafter, information annotated on pathological slide images may be referred to as metadata.

The “medical information” may refer to any medically meaningful information that may be extracted from medical images. For example, the medical information may include at least one of immune phenotype, genotype, biomarker score, tumor purity, information about ribonucleic acid (RNA), information about tumor microenvironment, or a cancer treatment method represented in a pathological slide image.

In addition, the medical information may include areas, positions, and sizes of specific tissue (e.g., cancer tissue, cancer stromal tissue, etc.) and/or specific cells (e.g., tumor cells, lymphocyte cells, macrophage cells, endothelial cells, fibroblast cells, etc.) within a medical image, cancer diagnosis information, information related to the likelihood of a subject developing cancer, and/or medical conclusions related to cancer treatment, but the disclosure is not limited thereto.

In addition, the medical information may include not only quantified values that may be obtained from medical images, but also information visualizing the values, prediction information based on the values, image information, statistical information, etc.

For example, the medical information may be provided to a user terminal or output through a display device.

Hereinafter, embodiments are described in detail with reference to the accompanying drawings. However, the embodiments may be implemented in various different forms and are not limited to examples described herein.

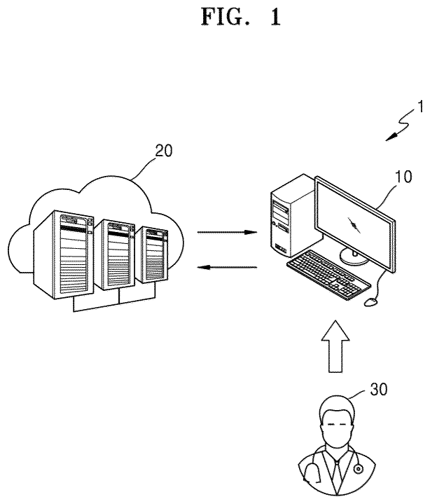

FIG. 1 is a diagram for describing an example of a system for analyzing a pathological slide image, according to an embodiment.

Referring to FIG. 1, the system includes a user terminal 10 and a server 20. For example, the user terminal 10 and the server 20 may be connected to each other in a wired or wireless communication scheme and may transmit and receive various data therebetween.

For convenience of explanation, FIG. 1 illustrates that the system includes the user terminal 10 and the server 20, but the disclosure is not limited thereto. For example, the system may include other external devices (not shown). In addition, the operations of the user terminal 10 and the server 20 to be described below may be implemented by a single device (e.g., the user terminal 10 or the server 20) or more devices.

The user terminal 10 may be a computing device that includes a display device, a device that receives user input (e.g., a keyboard, a mouse, etc.), a memory, and a processor. In addition, the display device may be implemented as a touch screen to perform the function of receiving user input. For example, the user terminal 10 may include a notebook personal computer (PC), a desktop PC, a laptop, a tablet computer, a smartphone, etc., but the disclosure is not limited thereto.

The server 20 may be a device that communicates with an external device (not shown) including the user terminal 10. For example, the server 20 may store various data, including a pathological slide image, a bitmap image corresponding to the pathological slide image, a heatmap image corresponding to the pathological slide image, information generated by analyzing the pathological slide image (e.g., information about an area of at least one cell, tissue, or structure represented in the pathological slide image, information about at least one biomarker expression, medical information related to the pathological slide image, etc.), metadata annotated on the pathological slide image, and information about an artificial intelligence (AI) model used to analyze the pathological slide image. Alternatively, the server 20 may be a computing device that includes a memory and a processor and has built-in computing capabilities. When the server 20 is a computing device, the server 20 may perform at least some of the operations of the user terminal 10, which will be described below with reference to FIGS. 1 to 19. For example, the server 20 may be a cloud server, but the disclosure is not limited thereto.

The user terminal 10 outputs a pathological slide image and/or information generated by analyzing a pathological slide. For example, the user terminal 10 may output various pieces of information about an area of at least one cell, tissue, or structure represented in the pathological slide image. In addition, the user terminal 10 may output biomarker expression information. As an example, the user terminal 10 may output cell expression classes of a plurality of tumor cells identified from the pathological slide image and/or slide expression classes of the pathological slide image.

The pathological slide image may refer to an image of a pathological slide that has been fixed and stained through a series of chemical treatments so as to observe tissue removed from the human body by using a microscope. As an example, the pathological slide image may refer to a WSI including a high-resolution image of a whole slide. As another example, the pathological slide image may refer to a portion of the high-resolution WSI.

On the other hand, the pathological slide image may refer to an area segmented from the WSI in units of patches (or tiles). For example, the patch (or tile) may have a certain area size.

In addition, the pathological slide image may refer to a digital image captured by using a microscope and may include information about cells, tissue, and/or structures within the human body.

Biological factors (e.g., cancer cells, immune cells, tumor areas, stromal areas, specific structures, etc.) represented in the pathological slide image may be identified by analyzing the pathological slide image. The biological factors may be used for histological diagnosis of disease, prediction of disease prognosis, and determination of disease treatment planning.

The user terminal 10 may analyze the pathological slide image by using an AI model. For example, the user terminal 10 may use the AI model to individually detect many cells distributed on the pathological slide image and segment areas in tissue. The user terminal 10 may analyze the detected cells and the segmented areas, which are obtained by using the AI model, and may derive a result of the analyzing.

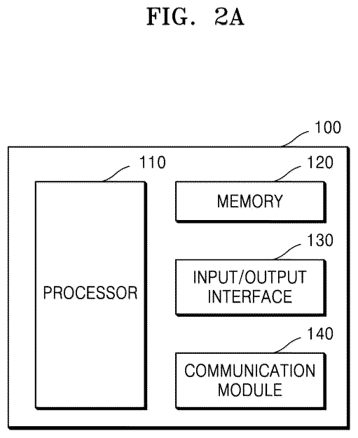

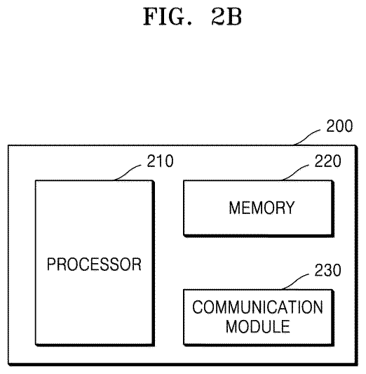

Hereinafter, an example in which the user terminal 10 analyzes the pathological slide image is described with reference to FIGS. 2 to 19.

On the other hand, for convenience of explanation, it has been described throughout the specification that the user terminal 10 performs all operations, but the disclosure is not limited thereto. For example, at least some of the operations that are performed by the user terminal 10 may be performed by the server 20.

FIG. 2A is a configuration diagram illustrating an example of a user terminal according to an embodiment.

Referring to FIG. 2A, a user terminal 100 includes a processor 110, a memory 120, an input/output interface 130, and a communication module 140. For convenience of explanation, only elements related to the disclosure are illustrated in FIG. 2A. Accordingly, in addition to the elements illustrated in FIG. 2A, other general-purpose elements may be further included in the user terminal 100. In addition, it is obvious to those of ordinary skill in the art that the processor 110, the memory 120, the input/output interface 130, and the communication module 140 illustrated in FIG. 2A may be implemented as independent devices.

The processor 110 may process commands of a computer program by performing basic arithmetic, logic, and input/output operations. The commands may be provided from the memory 120 or an external device (e.g., the server 20, etc.). In addition, the processor 110 may control the overall operations of other elements included in the user terminal 100.

The processor 110 may detect a plurality of tumor cells included in one or more tumor areas from a pathological slide image. At this time, the one or more tumor areas may include a first tumor area or a second tumor area according to whether a tumor has proliferated.

On the other hand, the processor 110 may identify one or more tumor areas and a plurality of tumor cells from a pathological slide image by using an AI model. Specifically, the processor 110 may identify a plurality of tumor cells from a pathological slide image by using a first AI model. As an example, the processor 110 may identify a pixel corresponding to a tumor area by analyzing a pathological slide image in units of pixels. In addition, the processor 110 may identify one or more tumor areas from a pathological slide image by using a second AI model. Thereafter, the processor 110 may extract tumor cells included in a tumor area from among the plurality of identified tumor cells.

The processor 110 may determine cell expression classes of the plurality of tumor cells, based on the degree of biomarker expression of the plurality of tumor cells. The processor 110 may determine an analysis condition, based on at least one of user input, preset conditions, or metadata included in the pathological slide image, and may determine an evaluation criterion for determining the cell expression classes of the plurality of tumor cells, based on the analysis condition.

The processor 110 may calculate the percentage of each of cell expression classes, based on the number of tumor cells included in the cell expression classes. In addition, the processor 110 may predict therapeutic responsiveness to at least one carcinoma of a patient associated with the pathological slide image, based on the percentage.

The processor 110 may generate a heatmap image for the pathological slide image, based on a result of the determining. As an example, the processor 110 may generate a first heatmap image, based on cell expression classes of a plurality of tumor cells included in the first tumor area, and may generate a second heatmap image, based on cell expression classes of a plurality of tumor cells included in the second tumor area.

In addition, as an example, the processor 110 may generate a plurality of cell images, based on the positions of the plurality of detected tumor cells on the pathological slide image and the determined cell expression classes, and may generate a plurality of layers respectively corresponding to the cell expression classes by performing a convolution operation on the plurality of cell images. At this time, the plurality of layers may be those normalized based on reference layers corresponding to the plurality of tumor cells. In addition, the plurality of layers may be expressed in different colors for each cell expression class and may be expressed with different transparencies according to the number of tumor cells included in the cell expression class.

Thereafter, the processor 110 may generate a heatmap image by overlaying the plurality of layers. As an example, the processor 110 may control the display device so that the heatmap image is output while being overlapped on the pathological slide image.

On the other hand, the processor 110 may output a plurality of tumor cells included in one or more tumor areas and detected from the pathological slide image. In addition, the processor 110 may output the cell expression class of each of the plurality of tumor cells. Furthermore, the processor 110 may output the heatmap image for the pathological slide image. For example, the processor 110 may control the display device to output at least one of a report or therapeutic responsiveness predicted based on the percentage of each of the cell expression classes described above.

The processor 110 may be implemented as an array of a plurality of logic gates, or may be implemented as a combination of a general-purpose microprocessor and a memory storing a program that is executable on the microprocessor. For example, the processor 110 may include a general-purpose processor, a central processing unit (CPU), a microprocessor, a digital signal processor (DSP), a controller, a microcontroller, a state machine, and the like. In some environments, the processor 110 may include an application-specific integrated circuit (ASIC), a programmable logic device (PLD), a field programmable gate array (FPGA), and the like. For example, the processor 110 may be a combination of processing devices, for example, a combination of a DSP and a microprocessor, a combination of a plurality of microprocessors, a combination of one or more microprocessors connected to a DSP core, or a combination of any other configurations.

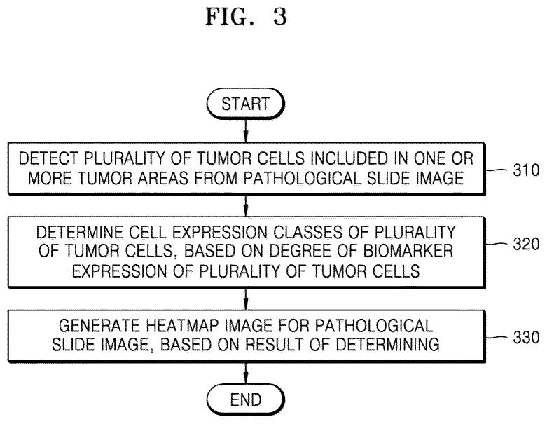

The memory 120 may include any non-transitory computer-readable recording medium. As an example, the memory 120 may include a permanent mass storage device, such as random access memory (RAM), read-only memory (ROM), disk drive, solid state drive (SSD), or flash memory. As another example, the permanent mass storage device, such as ROM, SSD, flash memory, or disk drive, may be a separate permanent storage device distinct from memory. In addition, the memory 120 may store an operating system (OS) and at least one program code (e.g., code for causing the processor 110 to perform operations to be described below with reference to FIGS. 3 to 19).

Such software components may be loaded from a computer-readable recording medium separate from the memory 120. The separate computer-readable recording medium may be a recording medium that may be directly connected to the user terminal 100. Examples of the separate computer-readable recording medium may include floppy drive, disk, tape, digital versatile disc/compact disc read-only memory (DVD/CD-ROM) drive, and memory card. Alternatively, the software components may be loaded into the memory 120 through the communication module 140 rather than the computer-readable recording medium. For example, the at least one program may be loaded into the memory 120, based on a computer program installed by files provided through the communication module 140 by developers or a file distribution system that distributes an application installation file (e.g., a computer program for causing the processor 110 to perform operations described below with reference to FIGS. 3 to 19).

The input/output interface 130 may be a means for interfacing with an input or output device (e.g., a keyboard, a mouse, etc.) that may be connected to or included in the user terminal 100. FIG. 2A illustrates that the input/output interface 130 is an element configured separately from the processor 110, but the disclosure is not limited thereto, and the input/output interface 130 may be configured to be included in the processor 110.

The communication module 140 may provide a configuration or a function for the server 200 and the user terminal 100 to communicate with each other via a network. In addition, the communication module 140 may provide a configuration or a function for the user terminal 100 to communicate with other external devices. For example, control signals, commands, data, and the like, which are provided under the control of the processor 110, may be transmitted to the server 200 and/or an external device via the communication module 140 and the network.

On the other hand, although not illustrated in FIG. 2A, the user terminal 100 may further include a display device. Alternatively, the user terminal 100 may be connected to an independent display device in a wired or wireless communication scheme and may transmit and receive data therebetween. For example, a pathological slide image, analysis information of the pathological slide image, medical information, additional information based on the medical information, and the like may be provided to a user 30 through the display device.

FIG. 2B is a configuration diagram illustrating an example of a server according to an embodiment.

Referring to FIG. 2B, a server 200 includes a processor 210, a memory 220, and a communication module 230. For convenience of explanation, only elements related to the disclosure are illustrated in FIG. 2B. Accordingly, in addition to the elements illustrated in FIG. 2B, other general-purpose elements may be further included in the server 200. In addition, it is obvious to those of ordinary skill in the art that the processor 210, the memory 220, the communication module 230 illustrated in FIG. 2B may be implemented as independent devices.

The processor 210 may obtain a pathological slide image from at least one of the memory 220, the user terminal 100, or other external devices. The processor 210 may detect a plurality of tumor cells included in one or more tumor areas from the pathological slide image, may generate information related to the plurality of detected tumor cells included in the one or more tumor areas (e.g., a result of determining a cell expression class of each of the plurality of tumor cells), may predict a patient's therapeutic responsiveness associated with the pathological slide image (e.g., a slide expression class of the pathological slide image), based on the generated information, or may transmit at least one of the plurality of detected tumor cells, the generated information, or the predicted therapeutic responsiveness to the user terminal 100. In addition, the processor 210 may transmit a report (e.g., including the cell expression class of each of the plurality of tumor cells or the therapeutic responsiveness corresponding to the pathological slide image) to the user terminal 100.

In other words, at least one of the operations of the processor 110 described above with reference to FIG. 2A may be performed by the processor 210. In this case, the user terminal 100 may output information transmitted from the server 200 through the display device.

On the other hand, since the embodiment of the processor 210 is the same as the embodiment of the processor 110 described above with reference to FIG. 2A, a detailed description thereof is omitted.

The memory 220 may store various data, such as the pathological slide image and the data generated according to the operation of the processor 210. In addition, the memory 220 may store an OS and at least one program (e.g., a program necessary for the operation of the processor 210, etc.).

On the other hand, since the embodiment of the memory 220 is the same as the embodiment of the memory 120 described above with reference to FIG. 2A, a detailed description thereof is omitted.

The communication module 230 may provide a configuration or a function for the server 200 and the user terminal 100 to communicate with each other via a network. In addition, the communication module 230 may provide a configuration or a function for the server 200 to communicate with other external devices. For example, control signals, commands, data, and the like, which are provided under the control of the processor 210, may be transmitted to the user terminal 100 and/or an external device via the communication module 230 and the network.

FIG. 3 is a flowchart for describing an example of a method of analyzing a pathological slide image, according to an embodiment.

The method illustrated in FIG. 3 includes operations that are processed in time series by the user terminal 10 or 100 or the processor 110 illustrated in FIGS. 1 and 2A. Therefore, even when omitted below, the descriptions of the user terminals 10 and 100 or the processor 110 illustrated in FIGS. 1 to 2A may also be applied to the method illustrated in FIG. 3.

In addition, as described above with reference to FIGS. 1 to 2B, at least one operation of the method illustrated in FIG. 3 may be processed by the server 20 or 200 or the processor 210.

In operation 310, the processor detects a plurality of tumor cells included in one or more tumor areas (cancer areas) from a pathological slide image.

In the disclosure, the pathological slide image may be a WSI or a portion of the WSI. A portion of the WSI may be referred to as a patch or a tile.

In an embodiment, the processor may recognize an area where artifacts included in the pathological slide image exist and may exclude the recognized area from analysis and display of the pathological slide image, which will be described below. For example, the artifacts may include pen marks, folds in tissue, out-of-focus areas, and air bubbles trapped between cover glasses. In addition, the processor may recognize areas (e.g., control tissue) that need to be excluded from analysis in addition to areas where artifacts exist and may exclude the recognized areas from the analysis of the pathological slide image.

In the disclosure, the one or more tumor areas may include a cancer area or a carcinoma in situ (CIS) area.

In an embodiment, the processor may analyze the pathological slide image to identify or classify the cancer area or the CIS area from the pathological slide image according to whether a tumor has proliferated (or, spread, invaded). In addition, the processor may classify a plurality of cells represented in the pathological slide image into at least one of tumor cells or other cells. The processor may determine the positions and the areas of the identified cancer area and the identified CIS area. In addition, the processor may determine the number of the plurality of cells. In addition, the processor may determine biological information (e.g., biomarker expression information and cell expression class) of each of the plurality of identified tumor cells.

In addition, the biomarker expression information may include the degree of expression of human epidermal growth factor receptor 2 (HER2), the number and proportion of cells corresponding to each degree of expression, a score in accordance with a HER2 reading guideline at a pathological slide level, and a tumor proportion score (TPS), and the like. However, the biomarker expression information is not limited thereto.

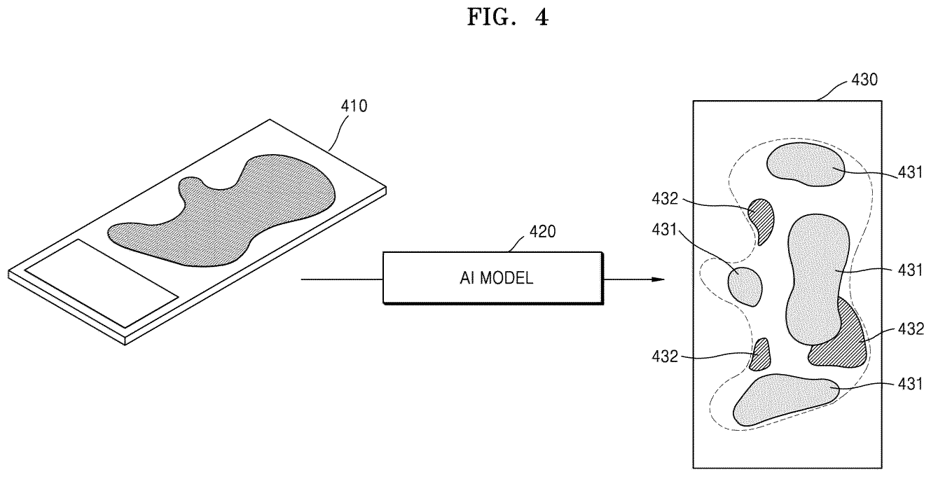

FIG. 4 is a diagram for describing an example of detecting tumor cells from a pathological slide image, according to an embodiment.

Referring to FIG. 4, in an embodiment, the processor may detect a plurality of tumor cells included in one or more tumor areas from a pathological slide image 430. Specifically, the processor may identify a plurality of tumor cells (not shown) and one or more tumor areas 431 included in the pathological slide image 430, which is an image obtained by capturing a pathological slide 410. The pathological slide image 430 may be an image obtained by capturing the pathological slide 410 in which tissue removed from the human body has been fixed and stained through a series of chemical treatments. As an example, the processor may identify, in addition to the tumor area 431, a stromal area 432 from the pathological slide image 430.

In an embodiment, the one or more tumor areas 431 may be classified into a first tumor area or a second tumor area according to whether a tumor has proliferated (or, spread, invaded). For example, the first tumor area may be a cancer area and the second tumor area may be a CIS area. The cancer area may refer to an area where a tumor occurs and grows and may refer to an advanced stage tumor area where a tumor may proliferate to neighboring tissue. The CIS area may refer to an early stage tumor area where tumor cells exist only in one place and a tumor has not yet proliferated to neighboring tissue. In the case of the CIS area, therapy and curability may differ depending on the time of discovery, compared to the cancer area. Accordingly, when analyzing the pathological slide image 430, a method of analyzing the cancer area and the CIS area separately may be required.

In an embodiment, the processor may use an AI model 420 to detect the one or more tumor areas and the plurality of tumor cells. At this time, the AI model 420 may be a machine learning model. As an example, the AI model 420 may be trained to infer histological information about all or part of the pathological slide image 430 (e.g., at least one patch included in the pathological slide image 430). In this case, histological information generated through an annotation process may be used to train the AI model 420. For example, the histological information may include information (e.g., the number of specific cells or information about tissue in which specific cells are placed) about cells within the patch (e.g., tumor cells, lymphocyte, macrophage cells, dendritic cells, fibroblast, endothelial cells, the first tumor area (e.g., the cancer area), the second tumor area (e.g., the CIS area, etc.), but the disclosure is not limited thereto. As another example, the AI model 420 may be trained to infer characteristics of at least one of cells, tissue, or structures within the pathological slide image 430. As an example, the AI model 420 may extract a plurality of tumor cells included in a tumor area from among the plurality of identified tumor cells.

In an embodiment, the AI model 420 may include a first AI model and a second AI model. For example, the first AI model may be a cell detection model and the second AI model may be a tissue detection model.

At this time, the first AI model may be a model trained to identify a plurality of tumor cells from the pathological slide image 430. In an embodiment, the first AI model may identify a plurality of tumor cells by determining information about an area where cells are disposed in the pathological slide image 430 by using the histological information. As an example, the processor may use the first AI model to determine a class of the plurality of tumor cells as one of the plurality of the cell expression classes according to the degree of specific biomarker expression of the plurality of tumor cells.

In addition, the second AI model may be a model trained to identify the one or more tumor areas 431 (i.e., the first tumor area and the second tumor area) from the pathological slide image 430. As an example, the processor may detect the one or more tumor areas 431 by analyzing the pathological slide image 430 in units of pixels by using the second AI model and identifying pixels determined as the tumor areas 431. For example, the second AI model may identify pixels corresponding to tumor areas by analyzing the pathological slide image 430 in units of pixels and may extract the boundaries of the one or more tumor areas 431. However, the embodiment in which the processor identifies the one or more tumor areas 431 from the pathological slide image 430 by using the second AI model is not limited thereto.

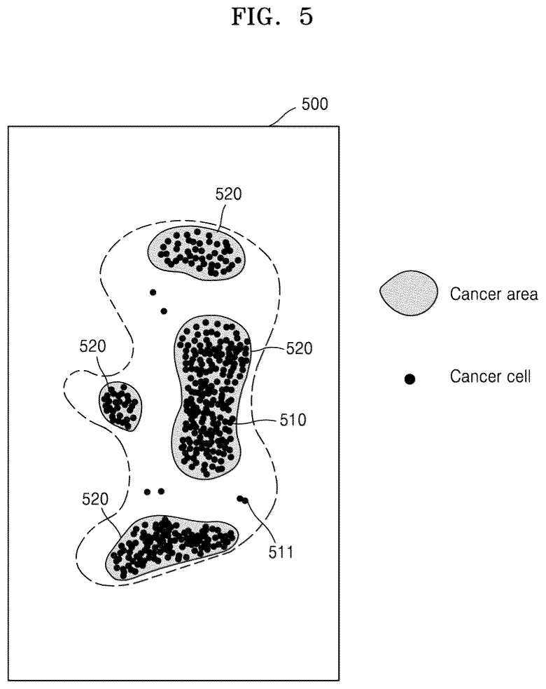

FIG. 5 is a diagram illustrating tumor areas and tumor cells according to an embodiment.

Referring to FIG. 5, a pathological slide image 500 shows a plurality of tumor cells 510 included in tumor areas 520 and a plurality of tumor cells 511 located outside the tumor areas 520.

As described above, the processor may identify the plurality of tumor cells 510 and 511 and one or more tumor areas 520 from the pathological slide image 500. In an embodiment, the processor may extract the plurality of tumor cells 510 included in the tumor areas 520 from among the plurality of identified tumor cells 510 and 511.

In an embodiment, the first AI model and the second AI model may deliver to each other their respective information (e.g., information about tumor cells and information about tumor areas) regarding the plurality of identified tumor cells 510 and 511 and the one or more tumor areas 520. For example, the processor may extract the plurality of tumor cells 510 included in the tumor areas 520, based on information including the areas, positions, sizes, types, and the like of the plurality of tumor cells 510 and 511 and the one or more tumor areas 520 identified from the pathological slide image 500.

Referring again to FIG. 3, in operation 320, the processor may determine the cell expression classes of the plurality of tumor cells, based on the degree of biomarker expression of the plurality of tumor cells. As an example, the processor may determine the plurality of tumor cells as one of the preset cell expression classes.

In addition, for example, the degree of biomarker expression may be the degree of HER2 expression. The HER2 is a protein receptor that regulates cell growth and division. When too many replications of HER2 gene occur, excessive HER2 protein may be produced in cancer tissue, which may promote tumor growth and metastasis. Therefore, the degree of HER2 expression of tumor cells may be an important indicator in the diagnosis and treatment of breast cancer. On the other hand, recent research has shown that HER2 may be an important biomarker not only in breast cancer but also in various carcinomas, including stomach cancer. However, the HER2 described above is only an example of a biomarker and is not limited thereto.

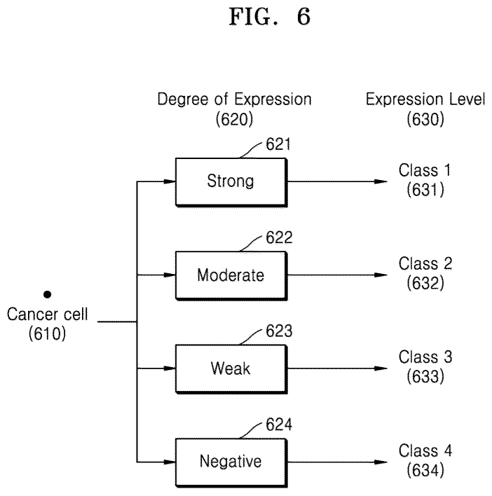

FIG. 6 is a diagram for describing a method of classifying a plurality of tumor cells, according to an embodiment of the disclosure.

Referring to FIG. 6, in an embodiment, the processor may determine cell expression classes 630 of a plurality of tumor cells 610 as one of preset cell expression classes 631 to 634, based on a degree 620 of biomarker expression of the plurality of tumor cells 610.

In an embodiment, the processor may determine an analysis condition, based on at least one of user input, preset conditions, or metadata of a pathological slide image. For example, the analysis condition may include a carcinoma to be analyzed. The carcinoma to be analyzed may include breast cancer and/or stomach cancer, but the disclosure is not limited thereto. In addition, the analysis condition may include a type of anticancer agent for which therapeutic responsiveness is to be confirmed. That is, the analysis condition may be received as user input or may be a preset condition.

On the other hand, the processor may determine the analysis condition, based on metadata included in the pathological slide image. As described above, medical information on which metadata is tagged may include at least one of the degree of biomarker expression (e.g., the degree of expression of HER2), a type of tumor area, immune phenotype, genotype, biomarker score, tumor purity, information about RNA, information about tumor microenvironment, or a treatment method for cancer represented in the pathological slide image, and may include the area, position, size of specific tissue and/or specific cell, diagnostic information for cancer, information related to the likelihood of a subject developing cancer, and/or medical conclusions related to cancer treatment. Accordingly, the processor may determine the analysis condition to be analyzed, such as carcinoma and type of anticancer drug, from the pathological slide image, based on the metadata.

Thereafter, the processor may determine an evaluation criterion for determining the cell expression classes and/or slide expression classes of the plurality of tumor cells 610, based on the analysis condition. As a non-limiting example, the evaluation criterion may include a cut-off value. As an example, the processor may receive user input of selecting at least one carcinoma, may determine the analysis condition, and may determine cut-off values corresponding to the selected at least one carcinoma. As another example, the processor may identify the type of anticancer drug from a slide image, based on metadata, may determine an analysis condition, and may determine cut-off values corresponding to the identified type of anticancer drug. The method of classifying the plurality of tumor cells 610 by using the cut-off values is described in detail below.

In the disclosure, a “HER2 expression continuous score” is a value obtained when the processor obtains information related to HER2 protein expression in a pathological slide image stained by an immunohistochemistry (IHC) method and quantifies HER2 expression, based on the obtained information.

In an embodiment, the processor may identify the degree 620 of biomarker expression of the plurality of tumor cells 610. For example, the processor may identify staining intensity of at least one of a nuclear membrane, a nucleus, a cytoplasm, or a nuclear membrane+cytoplasm for each of the plurality of tumor cells 610 and may generate a HER2 expression continuous score for each of the plurality of tumor cells 610. As an example, the HER2 expression continuous score may be determined as a value greater than or equal to 0 and less than or equal to 100.

In an embodiment, the processor may determine the cell expression class 630 by comparing the HER2 expression continuous score with the cut-off values. As an example, when the HER2 expression continuous score is greater than or equal to 0 and less than a first cut-off value, the processor may identify the cell expression class 630 of the corresponding tumor cell 610 as a fourth cell expression class 634. When the HER2 expression continuous score is greater than or equal to the first cut-off value and less than a second cut-off value, the processor may identify the cell expression class 630 of the corresponding tumor cell 610 as a third cell expression class 633. When the HER2 expression continuous score is greater than or equal to the second cut-off value and less than a third cut-off value, the processor may identify the cell expression class 630 of the corresponding tumor cell 610 as a second cell expression class 632. When the HER2 expression continuous score is greater than or equal to the third cut-off value and less than or equal to a fourth cut-off value (e.g., a maximum value, 100), the processor may identify the cell expression class 630 of the corresponding tumor cell 610 as a first cell expression class 631.

In an embodiment, the processor may identify whether the degree of HER2 staining in each of the plurality of tumor cells 610 is strong 621, moderate 622, weak 623, or negative 624, based on the HER2 expression continuous score. At this time, the evaluation criterion may be a light/dark boundary value (specifically, the cut-off value described above) on the pathological slide image that distinguishes the degree 620 of expression. As an example, when the HER2 expression continuous score is greater than or equal to 0 and less than the first cut-off value, the processor may identify that the degree 620 of expression of the corresponding tumor cell 610 is negative 624. When the HER2 expression continuous score is greater than or equal to the first cut-off value and less than the second cut-off value, the processor may identify that the degree 620 of expression of the corresponding tumor cell 610 is weak 623. When the HER2 expression continuous score is greater than or equal to the second cut-off value and less than the third cut-off value, the processor may identify that the degree 620 of expression of the corresponding tumor cell 610 is moderate 622. When the HER2 expression continuous score is greater than or equal to the third cut-off value and less than or equal to the fourth cut-off value (e.g., the maximum value, 100), the processor may identify that the degree 620 of expression of the corresponding tumor cell 610 is strong 621. However, the criterion by which the processor identifies the degree 620 of biomarker expression of the plurality of tumor cells 610 may be modified according to various embodiments.

On the other hand, the cut-off values described above (including the first to fourth cut-off values) may be differently set according to each carcinoma. Specifically, in a case where the carcinoma is breast cancer and in a case where the carcinoma is gastroesophageal adenocarcinoma, the first to fourth cut-off values may be differently set, but the disclosure is not limited thereto.

In an embodiment, when HER2 staining is strong 621 in the tumor cell 610, the processor may determine the cell expression class 630 as the first cell expression class 631. The first cell expression class 631 may be referred to as “3+positive.” For example, the tumor cell 610 that is determined as the first cell expression class 631 may be a tumor cell in which the sides or periphery of the cell membrane is completely stained with strong intensity. Similarly, when HER2 staining is moderate 622 in the tumor cell 610, the processor may determine the cell expression class 630 as the second cell expression class 632. The second cell expression class 632 may be referred to as “2+positive.” For example, the tumor cell 610 that is determined as the second cell expression class 632 may be a tumor cell in which the sides or periphery of the cell membrane is partially stained with weak/moderate intensity. In addition, when HER2 staining is weak 623 in the tumor cell 610, the processor may determine the cell expression class 630 as the third cell expression class 633. The third cell expression class 633 may be referred to as “1+positive.” For example, the tumor cell 610 that is determined as the third cell expression class 633 may be a tumor cell in which the cell membrane is partially stained with faint or unnoticeable intensity. Finally, when HER2 is hardly stained in the tumor cell 610 or when HER2 is not stained 624, the cell expression class 630 may be determined as the fourth cell expression class 634. The fourth cell expression class 634 may be referred to as “negative.” For example, the tumor cell 610 that is determined as the fourth cell expression class 634 may be a tumor cell in which a cell membrane is not stained.

At this time, in an embodiment, the processor may perform a re-identification and reclassification process on the tumor cell 610 determined as the second cell expression class 632. That is, the processor may re-identify the degree 620 of biomarker expression for the tumor cell 610 determined as the second cell expression class 632 and may determine the tumor cell 610 as the first cell expression class 631 or the third cell expression class 633.

In an embodiment, the at least two cell expression classes 631 to 634 may be preset. For example, the at least two cell expression classes 631 to 634 may be preset in accordance with an American Society of Clinical Oncology (ASCO)/College of American Pathologists (CAP) guideline. Alternatively, the at least two cell expression classes 631 to 634 may be set by a user according to various embodiments.

However, classifying, by the processor, the plurality of tumor cells 610 into the first to fourth cell expression classes 631 to 634 is only an example, and the number of cell expression classes and the terms referring to each cell expression class are not limited thereto. In addition, the determination of how many cell expression class 630 are needed to classify the plurality of tumor cells 610 may be determined according to carcinoma, or the like. For example, when the carcinoma is breast cancer, the cell expression class of the tumor cells may be determined as one of five expression classes, but when the carcinoma is gastroesophageal adenocarcinoma, the cell expression class of the tumor cells may be determined as one of four cell expression classes. However, this is only an example and the disclosure is not limited thereto.

As a non-limiting example, the cell expression class 630 may further include a fifth cell expression class. As an example, the fifth cell expression class may be referred to as “ultra-low.” Certain drugs may show effective therapeutic responsiveness even to tumor cells 610 that have weakly expressed HER2 staining intensity (i.e., staining intensity corresponding to a HER2 ultra-low level). As an example, the fifth cell expression class refers to a class that classifies tumor cells 610 with staining intensity that may be targeted by a specific drug from among the tumor cells 610 with the fourth cell expression class 634 having very weak staining intensity. The processor may determine whether a patient is likely to respond to a specific drug by distinguishing between the tumor cells 610 that do not respond to the specific drug (i.e., true HER2 negative) and the tumor cells 610 that have staining intensity of a HER2 ultra-low level and respond to the specific drug.

In an embodiment, the processor may determine the tumor cell 610 as one of the plurality of cell expression classes by using the cut-off values and the HER2 expression continuous score. The processor may determine the tumor cell 610 as one of the first to fifth cell expression classes by using the first to fifth cut-off values and the HER2 expression continuous score. That is, the tumor cells 610 in which the HER2 expression continuous score is greater than or equal to 0 and less than the fifth cut-off value may be identified as the fourth cell expression class 634, and the tumor cells 610 in which the HER2 expression continuous score is greater than or equal to the fifth cut-off value and less than the first cut-off value may be identified as the fifth cell expression class.

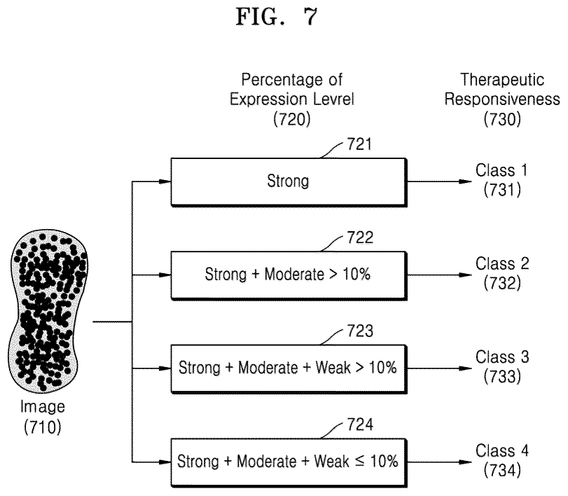

FIG. 7 is a diagram for describing a method of classifying a pathological slide image, according to an embodiment of the disclosure.

A HER2 IHC score refers to information that classifies an expression amount of a HER2 receptor protein of tumor cells within a pathological slide image 710 in accordance with a diagnostic criterion internationally agreed. The HER2 IHC score may be determined as HER2 IHC 0, HER2 IHC 1+, HER2 IHC 2+, HER2 IHC 3+, or the like according to the degree of staining of tumor cells within the pathological slide image 710. Specifically, when the number of tumor cells with completely and intensely stained cell membranes is greater than 10% of all tumor cells, the HER2 IHC score of the pathological slide image 710 may be determined to be 3. When the number of tumor cells with completely and intensely stained cell membranes is less than or equal to 10% of all tumor cells and the number of tumor cells with completely and intensely stained cell membranes or weakly-moderately stained cell membranes is greater than 10% of all tumor cells, the HER2 IHC score of the pathological slide image 710 may be determined to be 2. In addition, when the number of tumor cells with completely and intensely stained cell membranes is less than or equal to 10% of all tumor cells, the number of tumor cells with completely and intensely stained cell membranes or weakly-moderately stained cell membranes is less than or equal to 10% of all tumor cells, and the number of tumor cells with completely and intensely stained cell membranes, weakly-moderately stained cell membranes, or faintly stained cell membranes is greater than 10% of all tumor cells, the HER2 IHC score of the pathological slide image 710 may be determined to be 1. Finally, when the number of tumor cells in which unstained cell membranes are observed is greater than 90% of all tumor cells, the HER2 IHC score of the pathological slide image 710 may be determined to be 0. As a non-limiting example, a case where the HER2 IHC score of the pathological slide image 710 determined in accordance with the guidelines is 0 may be analyzed as HER2 negative, a case where the HER2 IHC score of the pathological slide image 710 is 3 (HER2 IHC 3+) may be analyzed as HER2 positive, and a case where the HER2 IHC score of the pathological slide image 710 is 1 (HER2 IHC 1+) or 2 (HER2 IHC 2+) may be analyzed as HER2 negative or HER2 positive by additionally performing HER2 Fluorescence In Situ Hybridization (FISH) evaluation. The HER2 IHC score of the pathological slide image 710 may be determined based on the proportion of tumor cells with specific HER2 staining intensity within the pathological slide image 710 obtained from a patient's human tissue, and a patient's response to HER2-targeted therapy may be predicted.

In the disclosure, the slide expression classes 731 to 734 may respectively correspond to HER2 IHC scores. As an example, the first slide expression class 731, the second slide expression class 732, the third slide expression class 733, and the fourth slide expression class 734 may respectively correspond to HER2 IHC 3+, HER2 IHC 2+, HER2 IHC 1+, and HER2 IHC 0.

In an embodiment, the processor may calculate a percentage 720 of expression level (hereinafter a percentage) of each of cell expression classes, based on the number of tumor cells respectively corresponding to cell expression classes. The percentage 720 means the ratio of tumor cells identified as a specific cell expression class with respect to the total tumor cells, expressed in percentile. In other words, the processor may calculate the percentage 720 based on the number of tumor cells classified into each of the cell expression classes with respect to the number of tumor cells included in the tumor areas in the pathological slide image 710.

For example, when the number of tumor cells included in the tumor areas is 100,000 and the number of tumor cells classified into the first cell expression class is 15,000, the processor may calculate the percentage of “strong” as 15%. Similarly, the processor may calculate the percentages of “moderate,” “weak,” and “negative,” based on the number of tumor cells classified into the second to fourth cell expression classes. The processor may determine the slide expression class of the pathological slide image 710, based on at least one of the percentages of “strong,” “moderate,” “weak,” and “negative.”

In an embodiment, the processor 110 may predict therapeutic responsiveness 730 for at least one carcinoma of a patient associated with the pathological slide image 710, based on the percentage 720. At this time, the processor may determine the slide expression classes 731 to 734 corresponding to the therapeutic responsiveness 730 as a result of predicting the therapeutic responsiveness 730.

As an example, in a case 721 where the percentage 720 of “strong” of a plurality of tumor cells included in one or more tumor areas identified from the pathological slide image 710 is greater than a certain value (e.g., 10%), the processor may classify the slide expression class of the pathological slide image 710 into the first slide expression class 731. For example, the first slide expression class 731 of the pathological slide image 710 may be referred to as “IHC 3+positive.” That is, when the proportion of the number of tumor cells having staining intensity of “3+positive” (i.e., the first cell expression class 631) among the total number of tumor cells within the pathological slide image 710 is greater than 10%, the processor may determine the pathological slide image 710 as the first slide expression class 731.

Similarly, when the pathological slide image 710 is not the first slide expression class 731 and the percentage 720 of the sum of the percentages of “strong” and “moderate” of the plurality of tumor cells included in one or more tumor areas identified from the pathological slide image 710 is greater than a certain value (e.g., 10%), the processor may classify the slide expression class of the pathological slide image 710 as the second slide expression class 732. For example, the second slide expression class 732 of the pathological slide image 710 may be “IHC 2+positive.” That is, when the proportion of the number of tumor cells having staining intensity of “3+positive” (i.e., the first cell expression class 631) among the total number of tumor cells within the pathological slide image 710 is less than or equal to 10% and the proportion of the sum of the number of tumor cells having staining intensity of “3+positive” and the number of tumor cells having staining intensity of “2+positive” (i.e., the second cell expression class 632) among the total number of tumor cells within the pathological slide image 710 is greater than 10%, the processor may determine the pathological slide image 710 as the second slide expression class 732.

In addition, in a case 723 where the pathological slide image 710 is not the first slide expression class 731 and the second slide expression class 732 and the percentage 720 of the sum of the percentages of “strong,” “moderate,” and “weak” of the plurality of tumor cells included in one or more tumor areas identified from the pathological slide image 710 is greater than a certain value (e.g., 10%), the processor may classify the slide expression class of the pathological slide image 710 as the third slide expression class 733. For example, the third slide expression class 733 of the pathological slide image 710 may be “IHC 1+positive.” That is, when the proportion of the number of tumor cells having staining intensity of “3+positive” (i.e., the first cell expression class 631) among the total number of tumor cells within the pathological slide image 710 is less than or equal to 10%, the proportion of the sum of the number of tumor cells having staining intensity of “3+positive” and the number of tumor cells having staining intensity of “2+positive” (i.e., the second cell expression class 632) among the total number of tumor cells within the pathological slide image 710 is less than or equal to 10%, and the proportion of the sum of the number of tumor cells having staining intensity of “3+positive,” the number of tumor cells having staining intensity of “2+positive,” and the number of tumor cells having staining intensity of “1+positive” (i.e., the third cell expression class 633) among the total number of tumor cells within the pathological slide image 710 is greater than 10%, the processor may determine the pathological slide image 710 as the third slide expression class 733.

Finally, in a case 724 where the percentage 720 of the sum of the percentages of “strong,” “moderate,” and “weak” of the plurality of tumor cells included in one or more tumor areas identified from the pathological slide image 710 is less than or equal to a certain value (e.g., 10%) or there are no stained tumor cells, the processor may classify the slide expression class of the pathological slide image 710 as the fourth slide expression class 734. For example, the fourth slide expression class 734 of the pathological slide image 710 may be “IHC 0 negative.” That is, when the proportion of the sum of the number of tumor cells having staining intensity of “3+positive,” the number of tumor cells having staining intensity of “2+positive,” and the number of tumor cells having staining intensity of “1+positive” among the total number of tumor cells within the pathological slide image 710 is less than 10%, or when there exist only tumor cells having staining intensity of “negative” (i.e., the fourth cell expression class 634) within the pathological slide image 710, the processor may determine the pathological slide image 710 as the fourth slide expression class 734.

In an embodiment, as the number of tumor cells having a high degree 620 of biomarker expression among the total number of tumor cells included in the tumor areas of the pathological slide image 710 increases, the processor may determine that therapeutic responsiveness 730 to a specific drug is good. As an example, when the pathological slide image 710 is classified into the first slide expression class 731, the processor may determine that a patient's therapeutic responsiveness 730 to a specific drug corresponding to the pathological slide image 710 is good.

In an embodiment, as the number of tumor cells having a specific degree 620 of expression among the total number of tumor cells included in the tumor areas of the pathological slide image 710 increases, the processor may determine that therapeutic responsiveness 730 to a specific drug is good. In an example, when the percentage 720 of the number of tumor cells having an expression level of a specific degree 620 of expression (e.g., the fourth cell expression class) among the total number of tumor cells included in one or more tumor areas identified from the pathological slide image 710 is greater than or equal to a certain value (e.g., 6%), the processor may classify the pathological slide image 710 into the fifth slide expression class (e.g., “ultra-low”). When the pathological slide image 710 is classified into the fifth slide expression class, the processor may determine that a patient's therapeutic responsiveness 730 to a specific drug corresponding to the pathological slide image 710 is good.

As another example, when the percentage 720 of the number of tumor cells corresponding to the fifth cell expression class (e.g., “ultra-low”) among the total number of tumor cells included in one or more tumor areas identified from the pathological slide image 710 is greater than or equal to a certain value (e.g., 10%), the processor may classify the pathological slide image 710 into the fifth slide expression class. That is, when the pathological slide image 710 is classified into the fifth slide expression class, the processor may determine that a patient's therapeutic responsiveness 730 to a specific drug corresponding to the pathological slide image 710 is good.

In an embodiment, the processor may re-identify and reclassify the tumor cells 610, which has been determined as the fourth cell expression class 634, into the fourth cell expression class 634 or the fifth cell expression class with respect to the pathological slide image 710 determined as the fourth slide expression class 734. That is, the processor may re-identify the degree 620 of biomarker expression or the HER2 expression continuous score with respect to the tumor cells 610 that have been primarily classified into the fourth cell expression class 634. The processor may identify, as the fourth cell expression class 634, the tumor cells 610 having a HER2 expression continuous score greater than or equal to 0 and less than the fifth cut-off value among the tumor cells 610 that have been primarily classified into the fourth cell expression class 634, and may identify, as the fifth cell expression class, the tumor cells 610 having a HER2 expression continuous score greater than or equal to the fifth cut-off value.

However, classifying, by the processor, the pathological slide image 710 into the first to fourth slide expression classes 731 to 734 is only an example, and the method by which the processor calculates the slide expression class, the number of slide expression classes corresponding to carcinoma, and the terms referring to the slide expression classes are not limited thereto. For example, the processor may calculate the therapeutic responsiveness 730 as quantitative values including certain medical information rather than classify the therapeutic responsiveness 730 into the slide expression classes 731 to 734.

Referring again to FIG. 3, in operation 330, the processor generates a heatmap image for the pathological slide image, based on a result of the determining.

In order to analyze the pathological slide images, both analysis at low magnification and analysis at high magnification have to be performed. For example, a user may perform effective pathological slide analysis by observing an entire pathological slide at low magnification and then observe individual cells and a distribution thereof at magnification increased focusing on a region of interest. However, when a user observes a pathological slide image at low magnification, there is an advantage of being able to observe many areas at once, but there is a problem in that medical information of individual cells (e.g., the degree of biomarker expression) may not be identified. In contrast, if the medical information of each of the numerous cells included in the pathology slide image is displayed on the screen to allow for identification of individual cell information even in low-magnification pathological slide images, there is a problem in that the load on the system may excessively increase. Therefore, there is a need to provide a system for outputting a pathological slide image, which is capable of identifying medical information about each of a plurality of tumor cells even at low magnification.

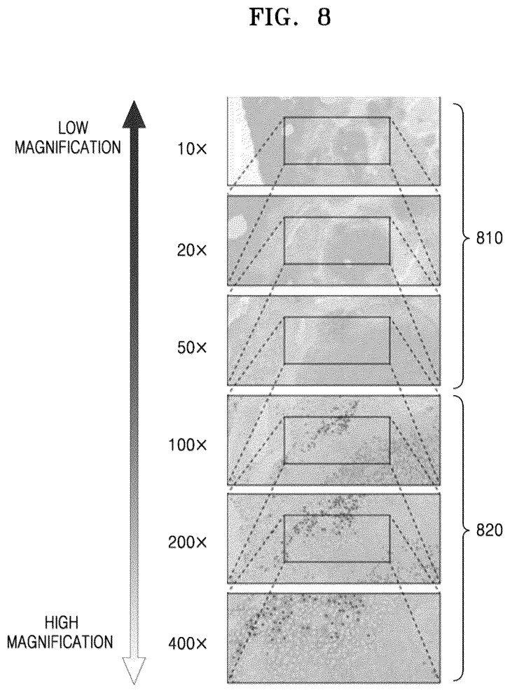

FIG. 8 is a diagram illustrating an example of pathological slide images respectively corresponding to magnifications, according to an embodiment of the disclosure.

Referring to FIG. 8, pathological slide images at low magnification 810 and pathological slide images at high magnification 820 are shown. For convenience of explanation, magnifications up to 50× are shown as the low magnification 810, and magnifications above 100× are shown as the high magnification 820, but the disclosure is not limited thereto.

In an embodiment, the processor may display pathological slide images so that a heatmap representing the distribution of tumor cells at the low magnification 810 appears.

The heatmap image means that various pieces of information expressible in color are output as visual graphics in the form of heat distribution on a certain image. In other words, the use of the heatmap image makes it possible to visually express the relative density or frequency of data.

That is, the processor may represent the degree of biomarker expression of tumor cells, that is, the distribution of cell expression classes in the pathological slide image, through the color of the heatmap, and may represent the density of tumor cells corresponding to the cell expression classes through transparency. Accordingly, since the processor displays the pathological slide images so that the heatmap representing the distribution of tumor cells appears at the low magnification 810, the user may observe and analyze a large area without a large computational load.

In an embodiment, the processor may display pathological slide images so that tumor cells appear at the high magnification 820. For example, the processor may display pathological slide images so that tumor cells appear as dots at the high magnification 820. At this time, the dots may be expressed in different colors according to the cell expression classes of the tumor cells. In addition, as an example, the processor may display pathological slide images so that the heatmap and the tumor cells appear overlaid at the high magnification 820. Accordingly, a user may identify tumor cells as well as the distribution and density of tumor cells, enabling more precise analysis.

On the other hand, the processor may display pathological slide images so that a tissue detection result appears. For example, the processor may display a first tumor area and a second tumor area. At this time, the processor may visualize the pathological slide image by segmenting areas corresponding to tissue and outputting the segmented areas in the form of different colors, transparency, and/or shading. In addition, the processor may display the pathological slide images so that the heatmap, the tumor cells, and the tissue detection result appear overlaid. Accordingly, the processor may provide an effect of enabling the user to identify the tissue area where the tumor cells corresponding to each of the cell expression classes are located and to visually identify the extent to which the corresponding tissue area is occupied within the pathological slide image, the difference in area between tissue areas, and the like. As a non-limiting example, the processor may display pathological slide images so that a tissue detection result do not appear at low magnification but do appear at specific magnification (e.g., medium magnification) as the magnification increases. In addition, as described below, since information such as the distribution and density of tumor cells are used while being prestored in units of pixels, there is an advantage in that a screen output by the system according to the disclosure may display such information by simply zooming in/out at various magnifications without a large computational load.

Hereinafter, a method, performed by a processor, of generating a heatmap image is described. In an embodiment, the processor may generate a heatmap image, based on cell expression classes into which a plurality of tumor cells are classified.

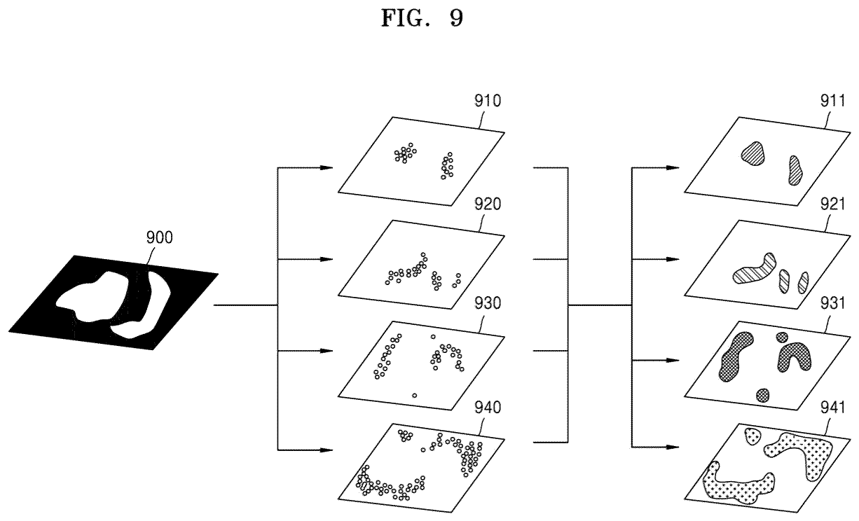

FIG. 9 is a diagram for describing a method of generating a plurality of layers, according to an embodiment of the disclosure.

A process by which the processor generates a plurality of layers 911 to 941 from a pathological slide image 900 is illustrated in FIG. 9.

In an embodiment, the processor may generate a plurality of cell images 910 to 940, based on the positions of a plurality of tumor cells included in one or more tumor areas on the pathological slide image 900 and the classified cell expression classes.

Each of the plurality of cell images 910 to 940 may correspond to one expression class among the plurality of cell expression classes, and the plurality of cell images 910 to 940 may include only a plurality of tumor cells belonging to the corresponding cell expression classes. That is, a cell image may be generated for each of the cell expression classes. For example, when a plurality of tumor cells included in a tumor area are classified into four cell expression classes according to the degree of biomarker expression, the cell image 910 of the first cell expression class, the cell image 920 of the second cell expression class, the cell image 930 of the third cell expression class, and the cell image 940 of the fourth cell expression class may be generated.

As described above, the pathological slide image 900 may be annotated with the positions and biomarker expression information of each of the plurality of tumor cells. Accordingly, the processor may generate the plurality of cell images 910 to 940 to correspond to the cell expression classes, based on the annotated information. As an example, the processor may convert position information of the tumor cells belonging to the cell expression classes into a matrix image and then generate the cell images 910 to 940 in which the number of cells is stored for each pixel. Specifically, the number of cells located at the corresponding pixel (which may be, for example, 0 or 1, or may be 2 or more when two or more cells are very close together) may be mapped to each pixel of the plurality of cell images 910 to 940.

On the other hand, the plurality of cell images 910 to 940 may be images reduced to specific magnification, compared to the original pathological slide image 900. For example, when a microns per pixel (MPP) value of the pathological slide image 900 is 0.121 μm/px, a MPP value of the plurality of cell images 910 to 940 may be 3.880 μm/px. That is, the plurality of cell images 910 to 940 may have a resolution reduced by 1/32 times that of the pathological slide image 900. Considering that an average diameter of lymphocytes is 7 μm, when the processor generates the plurality of cell images 910 to 940 having an MPP value of 3.880 μm/px or less, one pixel becomes smaller than a cell size. Accordingly, the plurality of cell images 910 to 940 may be generated with a size sufficient to represent the position of each cell. However, the resolution and MPP value of the plurality of cell images 910 to 940 are not limited to the embodiments described above.

In an embodiment, the processor may perform a convolution operation on the plurality of cell images 910 to 940 to generate the plurality of layers 911 to 941 corresponding to at least two cell expression classes.

As an example, the processor may perform a convolution operation by moving a kernel with a certain size within a cell image. For example, the kernel may have a circular shape and may have a diameter of 567.2 μm, but the disclosure is not limited thereto. Specifically, the processor may perform the convolution operation by moving the kernel with a certain size at regular intervals (e.g., 23.28 μm) within the cell image.

In an embodiment, the processor may generate a layer (hereinafter a “reference layer”) on which a convolution operation has been performed within the cell image for all of the plurality of tumor cells included in the pathological slide image 900, and may generate the plurality of layers 911 to 941 corresponding to the plurality of cell images 910 to 940 by performing a convolution operation within the plurality of cell images 910 to 940 generated to correspond to the cell expression classes. However, the processor may generate a reference layer by adding all of the plurality of layers 911 to 941.

In an embodiment, the plurality of layers 911 to 941 may be normalized based on the reference layer corresponding to the plurality of tumor cells. As an example, the processor may perform a convolution operation within the plurality of cell images 910 to 940 and segment the plurality of cell images 910 to 940 by the reference layer to generate the plurality of layers 911 to 941. Accordingly, the plurality of layers 911 to 941 may be normalized so that the sum of the densities of the plurality of tumor cells is 1.

In an embodiment, the plurality of layers 911 to 941 may be expressed in different colors for each cell expression class. For example, the layer 911 corresponding to the first cell expression class may be displayed in red, the layer 921 corresponding to the second cell expression class of the cell may be displayed in yellow, the layer 931 corresponding to the third cell expression class may be displayed in green, and the layer 941 corresponding to the fourth cell expression class may be displayed in blue.

In an embodiment, the plurality of layers 911 to 941 may be expressed with different transparency according to the number of tumor cells included in the cell expression class. For example, as the number of tumor cells included in each cell expression class increases, the plurality of layers 911 to 941 may be expressed with low transparency, and as the number of tumor cells included in each cell expression class decreases, the plurality of layers 911 to 941 may be expressed with high transparency.

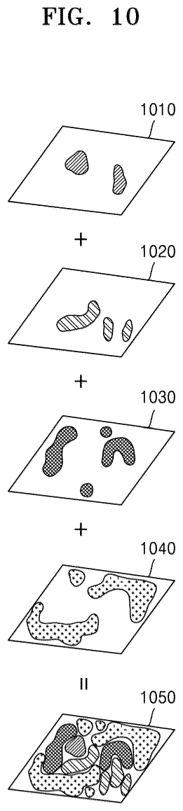

FIG. 10 is a diagram for describing a method of generating a heatmap image, according to an embodiment of the disclosure.

Referring to FIG. 10, in an embodiment, the processor may generate a heatmap image 1050 by overlaying a plurality of layers 1010 to 1040. Accordingly, the processor may output the heatmap image 1050 displayed in different colors and with different transparencies, or the like so that the plurality of layers 1010 to 1040 and the density of tumor cells may be distinguished.

In an embodiment, the processor may control the display device so that the heatmap image 1050 is output while being overlapped on a pathological slide image. Accordingly, since a user may determine the density of tumor cells and the degree of biomarker expression at a glance through the color and transparency of the plurality of layers 1010 to 1040, the processor may provide the user with the ease of analysis of pathological slide images. In addition, when the user analyzes a pathological slide image, there is an effect of making it easy to identify an area including cell expression classes of a plurality of cells at once. In particular, since the heatmap image 1050 is generated by overlaying the plurality of layers 1010 to 1040 expressed in different colors and with different transparencies, there is an effect in that the user may identify not only the areas according to each of the expression classes but also the overlapped parts thereof.

In an embodiment, when providing the pathological slide image, the processor may provide at least one of a magnification control function, a region-of-interest setting function, a display function for each expression class, or a display function for each tumor area.

As described above, when providing the pathological slide image at high magnification, the processor may visualize the degree of biomarker expression by displaying the plurality of tumor cells as dots with separate colors. In addition, when providing the pathological slide image at low magnification, the processor may display the heatmap image described above. For example, the processor may display the plurality of tumor cells as the heatmap image at low magnifications less than or equal to ×50 and may display the plurality of tumor cells as the dots at high magnifications greater than ×50. As another example, the processor may display the plurality of tumor cells as the heatmap image at low magnifications less than or equal to ×50 and may display the plurality of tumor cells as the dots together with the heatmap image at high magnifications greater than ×50.

In an embodiment, the plurality of layers 1010 to 1040 and the plurality of tumor cells may be expressed in colors according to the corresponding cell expression class. For example, the layer 1010 corresponding to the first cell expression class and the dot corresponding to the first cell expression class may be displayed in red, the layer 1020 corresponding to the second cell expression class and the dot corresponding to the second cell expression class may be displayed in yellow, the layer 1030 corresponding to the third cell expression class and the dot corresponding to the third cell expression class may be displayed in green, and the layer 1040 corresponding to the fourth cell expression class and the dot corresponding to the fourth cell expression class may be displayed in blue.

In an embodiment, the processor may provide a region-of-interest setting function. The processor may receive user input of setting a region of interest from the user and provide a pathological slide image corresponding to the region of interest. For example, the region of interest may be set in the form of a rectangular box or may be set in the form of a polygon connecting a plurality of points, but the disclosure is not limited thereto.

In an embodiment, the processor may provide a display function for each expression class. The processor may receive, from the user, user input of selecting at least one cell expression class from among at least two cell expression classes and may display only tumor cells corresponding to the selected cell expression class on the pathological slide image. However, for example, in the case of low magnification at which the heatmap is provided, the dot for each of the plurality of tumor cells is not displayed.

Accordingly, in another embodiment, the processor may display only layers corresponding to the selected cell expression class from among the plurality of layers 1010 to 1040.

In an embodiment, the processor may display information about the slide expression class and result information about which therapeutic responsiveness class the pathological slide image has been classified into.

In an embodiment, the processor may display information about the percentage of each cell expression class and result information about which expression class the pathological slide image has been classified into.

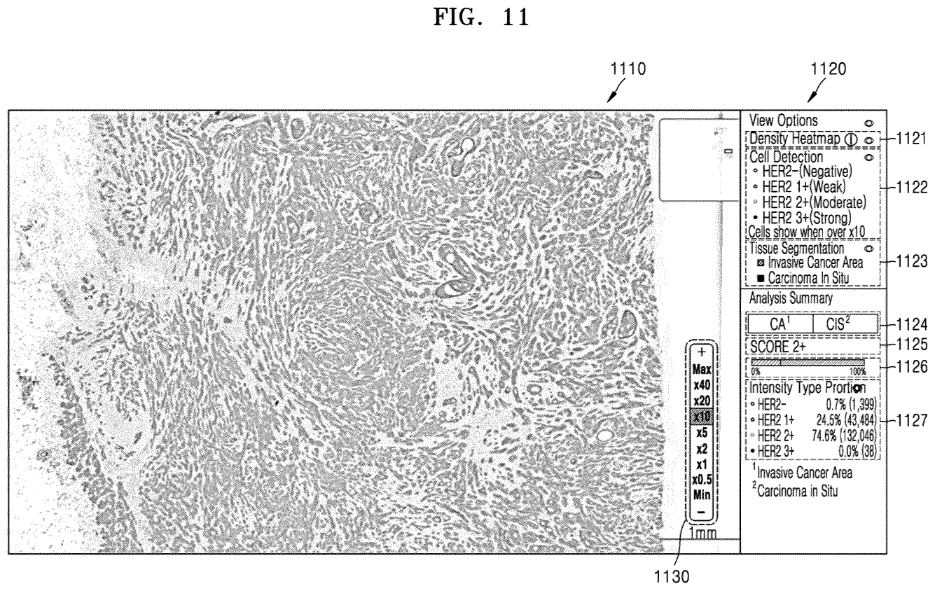

FIG. 11 is a diagram illustrating an example of a pathological slide image according to an embodiment of the disclosure.

In an embodiment, the processor may display a setting part 1120, which receives user input for a pathological slide image 1110 and displays certain information, together with the pathological slide image 1110. In addition, the processor may also display a magnification control part 1130 that selects a magnification for the pathological slide image 1110. Referring to FIG. 11, since ×5 magnification is selected by the magnification control part 1130, it may be confirmed that the currently displayed pathological slide image 1110 is a low-magnification image. Therefore, as described above, it may be confirmed that a heatmap image is output while overlapping the pathological slide image 1110 shown in FIG. 11.

In an embodiment, the setting part 1120 may include at least one of a heatmap output selection part 1121, a cell output selection part 1122, an area output selection part 1123, an area information display part 1124, a slide class display part 1125, or cell class display parts 1126 and 1127.

In an embodiment, the user may select whether to cause the heatmap output selection part 1121 to output the heatmap while overlapping the heatmap on the pathological slide image 1110. Therefore, when the processor obtains user input of not outputting the heatmap, the processor may display only the pathological slide image 1110, and when the processor obtains user input of outputting the heatmap, the processor may display the heatmap image while overlapping the heatmap image on the pathological slide image 1110.

In an embodiment, the user may select which cell expression class for tumor cells to output on the pathological slide image 1110 in the cell output selection part 1122. In addition, the cell output selection part 1122 may include information about the color in which the tumor cell corresponding to the cell expression class is expressed in the pathological slide image 1110. As an example, the cell color display part 1122 of FIG. 11 displays the first cell expression class, the second cell expression class, the third cell expression class, and the fourth cell expression class as HER2 3+(Strong), HER2 2+(Moderate), HER2 1+(Weak), and HER2− (Negative), respectively, but the disclosure is not limited thereto.

In an embodiment, the processor may obtain user input of selecting which tumor area to output on the pathological slide image 1110 by the area output selection part 1123. Alternatively, the processor may obtain user input of selecting which tumor area to highlight from among the tumor areas output on the pathological slide image 1110 by the area output selection part 1123. As an example, highlighting refers to a mark displayed in a color corresponding to the tumor area on the corresponding tumor area with certain transparency through which the pathological slide image 1110 is visible. In addition, the area output selection part 1123 may include information about the color to express the tumor area included in the pathological slide image 1110. For example, the tumor area included in the pathological slide image 1110 may include a first tumor area and a second tumor area and may be highlighted with different colors in the pathological slide image 1110. As an example, the tissue color display part 1123 of FIG. 11 displays the first tumor area as an invasive cancer area and the second tumor area as a CIS, but the disclosure is not limited thereto. At this time, the user may select only the first tumor area or the second tumor area through the area output selection part 1124, and may or may not select all tumor areas.

In an embodiment, the user may select which area whose information is to display among the tumor areas included in the pathological slide image 1110 in the area information display part 1124. For example, when the user selects the first tumor area in the area output selection part 1124 and the processor obtains user input of selecting the first tumor area, the processor may display information about the first tumor area of the current pathological slide image 1110 and information about the tumor cells included in the first tumor area. As an example, the information about the tumor area and the information about the tumor cells may be displayed on at least one of the slide class display part 1125, the first cell class display part 1126, the second cell class display part 1127, or the pathological slide image 1110. In addition, as a non-limiting example, the information about the tumor cells is information about the tumor cells included in the tumor area selected by the user, and may include the proportion of the tumor cells classified into each cell expression class, the number of cells classified into each cell expression class, and the like.

In an embodiment, the slide class display part 1125 displays the slide expression class of the pathological slide image 1110 that is currently being displayed. Referring to the cell class display parts 1126 and 1127 of FIG. 11, in the pathological slide image 1110, the proportion of tumor cells corresponding to the first cell expression class is about 0% and the proportion of tumor cells corresponding to the second cell expression class is about 74.6%. Accordingly, the slide expression class of the current pathological slide image 1110 may be determined as the second slide expression class according to the embodiment described above. As an example, the slide class display part 1125 of FIG. 11 shows the second slide expression class as SCORE 2+, but the disclosure is not limited thereto.

In an embodiment, the cell class display parts 1126 and 1127 display the proportion of tumor cells included in each cell expression class. As an example, the first cell class display part 1126 displays the proportion in the form of a bar, so that the user may intuitively confirm the proportion. As another example, the second cell class display part 1127 displays the proportion quantitatively, so that the user may confirm the proportion as an accurate value. Specifically, the second cell class display part 1127 displays the proportion and the number of tumor cells corresponding to each cell expression class. Accordingly, even in the pathological slide image 1110 having the same slide expression class, the degree of biomarker expression of the tumor cells included therein and the proportion of tumor cells belonging to each cell expression class may be easily confirmed.

Also, the slide class display part 1125 and the cell class display parts 1126 and 1127 may display the proportion of positive cells among the total tumor cells by classifying the expression classes of the tumor cells as either positive or negative. Alternatively, the slide class display part 1125 and the cell class display parts 1126 and 1127 may output the number of tumor cells detected in the WSI 1110 by adding the tumor cells in the areas not detected as the tumor areas. However, the information displayed by the slide class display part 1125 and the cell class display parts 1126 and 1127 is not limited thereto.

On the other hand, the slide class display part 1125 and the cell class display parts 1126 and 1127 may display only information about the area currently selected by the area output selection part 1124. For example, referring to FIG. 11, since the first tumor area is selected by the area output selection part 1124, the slide class display part 1125 and the cell class display parts 1126 and 1127 may display only information about the classes of the plurality of tumor cells (e.g., the cell expression class, the slide expression class) included in the first tumor area.

Hereinafter, an embodiment of displaying the first tumor area and the second tumor area is described.

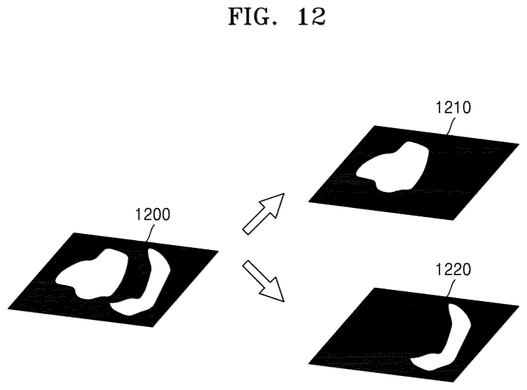

FIG. 12 is a diagram for describing a first tumor area and a second tumor area included in a pathological slide image, according to an embodiment of the disclosure.

Referring to FIG. 12, one or more tumor areas included in a pathological slide image 1200 may include a first tumor area 1210 and a second tumor area 1220. As an example, the first tumor area 1210 may be a cancer area and the second tumor area 1220 may be a CIS area.

In an embodiment, the processor may generate a first heatmap image, based on an expression class of each of a plurality of tumor cells included in the first tumor area 1210, and may generate a second heatmap image, based on an cell expression class of each of a plurality of tumor cells included in the second tumor area 1220. That is, as described above, the processor may provide a display function for each tumor area.

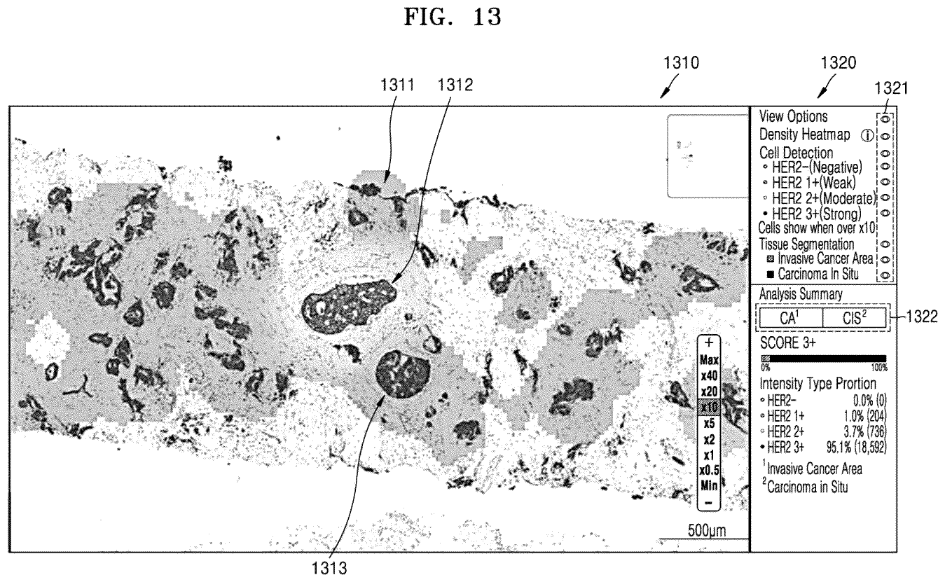

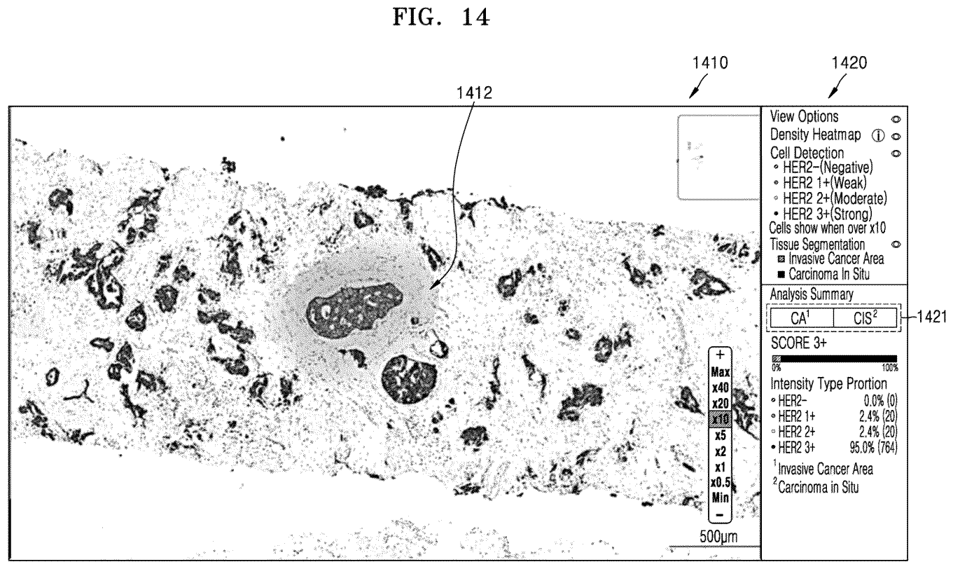

For example, the processor may receive user input of selecting a type of tumor area from a user and may display only tumor cells corresponding to the selected type of tumor area. For example, when the processor receives user input of selecting the CIS area 1220 from the user, the processor may display a plurality of tumor cells included in the CIS area 1220. At this time, the embodiments described above may be applied to the method, performed by the processor, of displaying the plurality of tumor cells included in the CIS area 1220. That is, the plurality of tumor cells included in the CIS area 1220 may be displayed based on the cell expression class, magnification, and region of interest. FIGS. 13 and 14 are diagrams illustrating an example of pathological slide images of a first tumor area and a second tumor area, according to an embodiment of the disclosure.

FIG. 13 shows a pathological slide image 1310 with a first tumor area highlighted and a setting part 1320, according to an embodiment of the disclosure.

In an embodiment, a heatmap output selection part, a cell output selection part, and an area selection output part of the setting part 1320 may each include an input part 1321. As described above with reference to FIG. 11, the input part 1321 may receive user input of determining whether to output an arbitrary item on the pathological slide image 1110.

As an example, when the user inputs “ON” for at least one cell expression class through the input part 1321 of the cell output selection part, the processor may display only dots corresponding to a selected specific cell expression class on a pathological slide image 1310, based on the user's selection input.

As an example, when the user inputs “ON” for both a first tumor area 1313 and a second tumor area 1312 through the input part 1321 of the area output selection part, the shown pathological slide image 1310 may be output to include both highlighting of the first tumor area 1313 and highlighting of the second tumor area 1312.

On the other hand, when the first tumor area is selected by the area information display part 1322, the processor may output a first heatmap image 1311 generated based on the cell expression class of each of the plurality of tumor cells included in the first tumor area, while being overlaid on the pathological slide image 1310. In addition, the processor may output a result of analyzing the tumor cells included in the first tumor area to at least one of a slide class display part, a first cell class display part, or a second cell class display part.

FIG. 14 shows a pathological slide image 1410 with a second tumor area highlighted and a setting part 1420, according to an embodiment of the disclosure.

Similarly, when the second tumor area is selected by an area information display part 1421, the processor may output a second heatmap image 1412 generated based on the cell expression class of each of a plurality of tumor cells included in the second tumor area, while being overlaid on the pathological slide image 1410. In addition, the processor may output a result of analyzing the tumor cells included in the second tumor area to at least one of a slide class display part, a first cell class display part, or a second cell class display part.

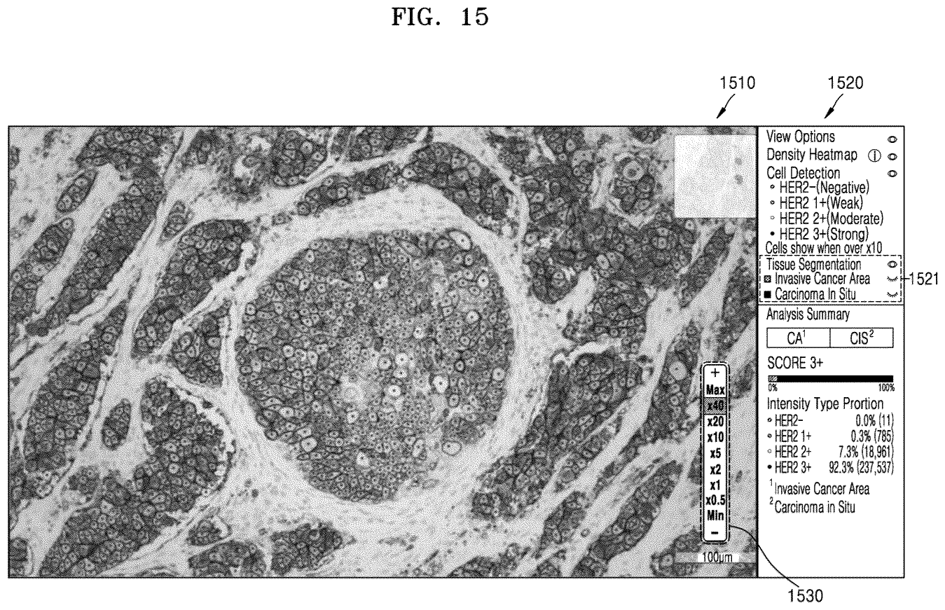

FIGS. 15 to 18 are diagrams illustrating an example of pathological slide images corresponding to user input, according to an embodiment of the disclosure.

FIGS. 15 to 18 show pathological slide images 1510, 1610, 1710, and 1810 with high magnification selected by the magnification control part 1530. Accordingly, referring to FIGS. 15 to 18, it may be confirmed that not only a heatmap image but also the pathological slide images 1510, 1610, 1710, and 1810 in which tumor cells are displayed as dots are output. Regarding setting parts 1520, 1620, 1720, and 1820 of FIGS. 15 to 18, descriptions redundant with those provided above with reference to FIG. 13 are omitted.

An area output selection part 1521 of FIG. 15 shows a case where “OFF” is input for both a first tumor area and a second tumor area. Accordingly, it may be confirmed that a heatmap image and a dot image of tumor cells are displayed on the pathological slide image 1510, but the first tumor area and the second tumor area are output without being highlighted.

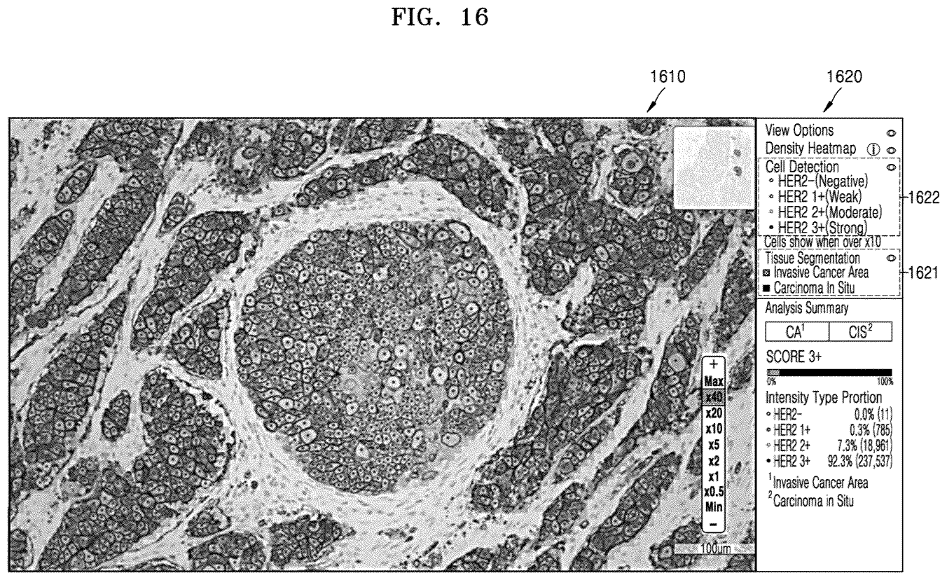

An area output selection part 1621 of FIG. 16 shows a case where “ON” is input for both a first tumor area and a second tumor area. Accordingly, it may be confirmed that a heatmap image and a dot image of tumor cells are output on a pathological slide image 1610 while the first tumor area and the second tumor area are highlighted.

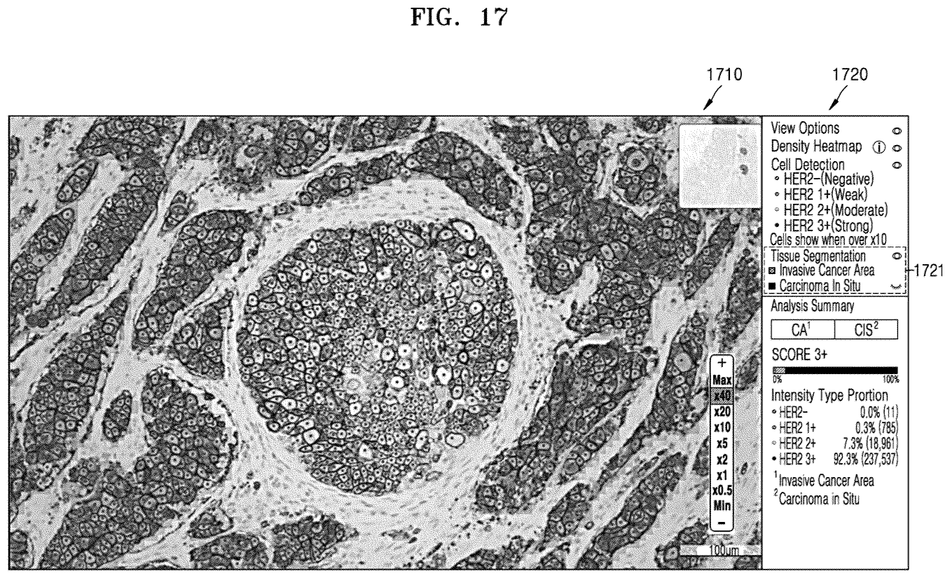

An area output selection part 1721 of FIG. 17 shows a case where “ON” is input for a first tumor area and “OFF” is input for a second tumor area. Accordingly, it may be confirmed that a heatmap image and a dot image of tumor cells are output on a pathological slide image 1710 while the first tumor area is highlighted.

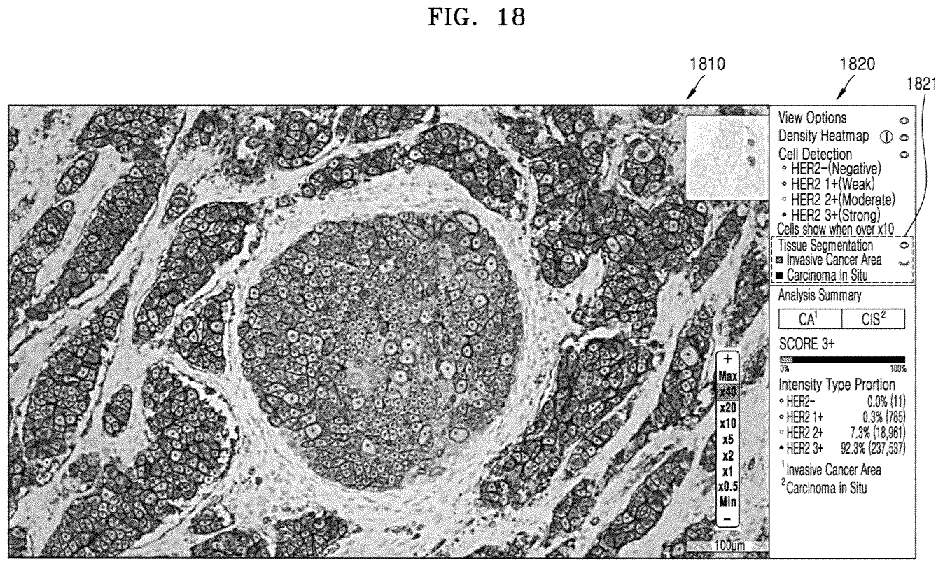

An area output selection part 1821 of FIG. 18 shows a case where “ON” is input for a second tumor area and “OFF” is input for a first tumor area. Accordingly, it may be confirmed that a heatmap image and a dot image of tumor cells are output on a pathological slide image 1810 while the second tumor area is highlighted.

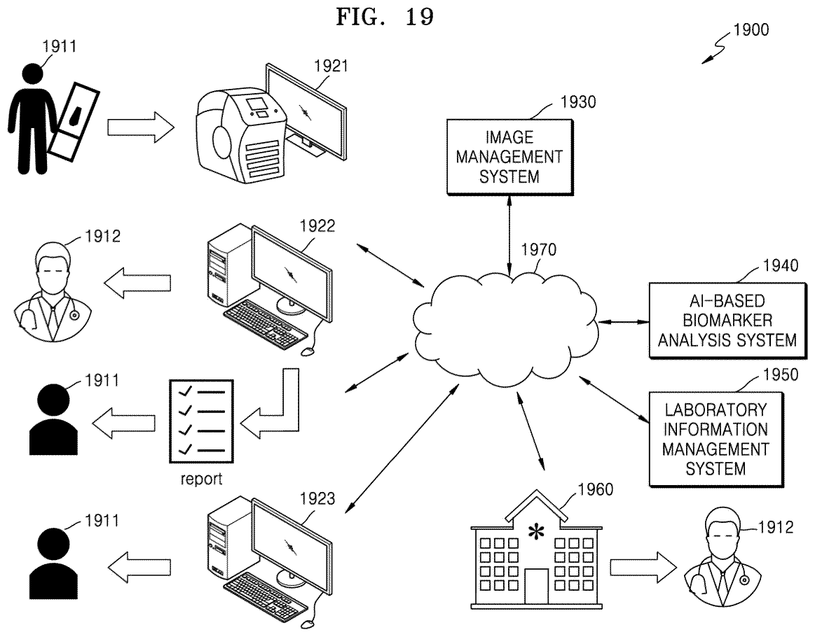

FIG. 19 is a diagram for describing another example of a system for analyzing a pathological slide image.

Referring to FIG. 19, a system 1900 is an example of a system and network for preparing, processing, and reviewing slide images of tissue samples by using an AI model.

According to various embodiments of the disclosure, the method described above with reference to FIGS. 2A to 18 may be performed by at least one of user terminals 1922 and 1923, an image management system 1930, an AI-based biomarker analysis system 1940, a laboratory information management system 1950, and a hospital or laboratory server 1960, or a combination thereof.

A scanner 1921 may obtain a digitized image from a tissue sample slide generated by using a tissue sample of a subject 1911. For example, the scanner 1921, the user terminals 1922 and 1923, the image management system 1930, the AI-based biomarker analysis systems 1940, the laboratory information management system 1950, and/or the hospital or laboratory server 1960 may be connected to a network 1970, such as the Internet, through one or more computers, servers, and/or mobile devices, or may communicate with a user 1912 through one or more computers and/or mobile devices.

The user terminals 1922 and 1923, the image management system 1930, the AI-based biomarker analysis system 1940, the laboratory information management system 1950, and/or the hospital or laboratory server 1960 may generate tissue samples of one or more subjects 1911, tissue sample slides (pathological slides), and digitized images of the tissue sample slides (pathological slides), or any combination thereof, otherwise, may be obtained from other devices. In addition, the user terminals 1922 and 1923, the image management system 1930, the AI-based biomarker analysis system 1940, the laboratory information management system 1950, and/or the hospital or laboratory server 1960 may obtain any combination of subject-specific information, such as age, medical history, cancer treatment history, family history, past biopsy records, or disease information of the subject 1911.

The scanner 1921, the user terminals 1922 and 1923, the AI-based biomarker analysis system 1940, the laboratory information management system 1950, and/or the hospital or laboratory server 1960 may transmit the digitized pathological slide image, the subject-specific information, and/or a result of analyzing the digitized pathological slide image to the image management system 1930 through the network 1970. For example, the result of the analyzing may be a heatmap image. The image management system 1930 may include a storage for storing the received images and a storage for storing the result of the analyzing.

In addition, according to various embodiments of the disclosure, an AI model learned and trained to predict at least one of information about at least one cell, information about at least one area, information related to a biomarker, medical diagnosis information, and/or medical treatment information from the pathological slide image of the subject 1911 may be operated while being stored in the user terminals 1922 and 1923 and the image management system 1930.

As described above, a computing device according to an embodiment of the disclosure may classify expression classes of tumor cells in a pathological slide image, may generate a heatmap image for the pathological slide image, and may automatically predict a patent's therapeutic responsiveness, based on a result of the classifying or the generated heatmap image. Therefore, it is possible to replace an analysis method by which a pathologist directly and only partially examines the distribution of tissue on an entire pathological slide image. In addition, the prediction accuracy and analysis speed of a patient's therapeutic responsiveness to anti-cancer immunotherapy drugs may be improved.

On the other hand, the methods described above may be written as a program that is executable on a computer, and may be implemented in a general-purpose digital computer that operates the program by using a computer-readable recording medium. In addition, data structures used in the methods described above may be recorded on a computer-readable recording medium through a variety of means. The computer-readable recording medium may include a storage medium, such as a magnetic storage medium (e.g., read-only memory (ROM), random access memory (RAM), universal serial bus (USB), floppy disk, hard disk, etc.) and an optical reading medium (e.g., compact disc-ROM (CD-ROM), digital versatile disc (DVD), etc.).

Those of ordinary skill in the art will understand that the disclosure may be implemented in modified forms without departing from the essential features of the disclosure. Therefore, the disclosed methods should be considered in an illustrative sense rather than a restrictive sense. The scope of the disclosure is indicated in the claims rather than the foregoing description, and all differences within the scope equivalent thereto should be construed as falling within the scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A computing device comprising:
at least one memory; and
at least one processor,
wherein the at least one processor is configured to:
detect a plurality of tumor cells included in one or more tumor areas from a pathological slide image;
determine a cell expression class of the plurality of tumor cells, based on a biomarker expression degree of the plurality of tumor cells; and
generate a heatmap image for the pathological slide image, based on a result of the determining.

2. The computing device of claim 1, wherein the at least one processor is further configured to control a display device to output the heatmap image while overlapping the pathological slide image.

3. The computing device of claim 1, wherein the at least one processor is further configured to:
identify one or more tumor areas and a plurality of tumor cells from the pathological slide image by using an artificial intelligence (AI) model; and
extract a plurality of tumor cells included in the one or more tumor areas from the plurality of identified tumor cells.

4. The computing device of claim 3, wherein the at least one processor is further configured to identify a pixel corresponding to the one or more tumor areas by analyzing the pathological slide image in units of pixels.

5. The computing device of claim 1, wherein the one or more tumor areas are classified into a first tumor area or a second tumor area according to whether a tumor has proliferated.

6. The computing device of claim 5, wherein the at least one processor is further configured to:
generate a first heatmap image, based on the cell expression class of each of a plurality of tumor cells included in the first tumor area; and
generate a second heatmap image, based on the cell expression class of each of a plurality of tumor cells included in the second tumor area.

7. The computing device of claim 1, wherein the at least one processor is further configured to:
determine an analysis condition, based on at least one of user input, preset conditions, or metadata annotated on the pathological slide image; and
determine an evaluation criterion for determining the cell expression class of the plurality of tumor cells, based on the analysis condition.

8. The computing device of claim 1, wherein the at least one processor is further configured to:
calculate a percentage of each of cell expression classes, based on a number of tumor cells corresponding to the cell expression class; and
predict a patient's therapeutic responsiveness associated with the pathological slide image, based on the percentage.

9. The computing device of claim 1, wherein the at least one processor is further configured to:
generate a plurality of cell images, based on positions of the plurality of detected tumor cells on the pathological slide image and the determined cell expression class;
generate a plurality of layers corresponding to the cell expression class by performing a convolution operation on the plurality of cell images; and
generate the heatmap image by overlaying the plurality of layers,
wherein the plurality of layers are normalized based on a reference layer corresponding to the plurality of tumor cells.

10. The computing device of claim 9, wherein the plurality of layers are expressed in different colors for each of the cell expression classes and with different transparencies according to a number of tumor cells corresponding to the cell expression classes.

11. A method of analyzing a pathological slide image, the method comprising:
detecting a plurality of tumor cells included in one or more tumor areas from a pathological slide image;
determining a cell expression class of the plurality of tumor cells, based on a biomarker expression degree of the plurality of tumor cells; and
generating a heatmap image for the pathological slide image, based on a result of the determining.

12. The method of claim 11, wherein the detecting comprises:
identifying one or more tumor areas and a plurality of tumor cells from the pathological slide image by using an artificial intelligence (AI) model; and
extracting a plurality of tumor cells included in the one or more tumor areas from the plurality of identified tumor cells.

13. The method of claim 12, wherein the identifying comprises identifying a pixel corresponding to the one or more tumor areas by analyzing the pathological slide image in units of pixels.

14. The method of claim 11, wherein the one or more tumor areas are classified into a first tumor area or a second tumor area according to whether a tumor has proliferated.

15. The method of claim 14, wherein the generating comprises:
generating a first heatmap image, based on the cell expression class of each of a plurality of tumor cells included in the first tumor area; and
generating a second heatmap image, based on the cell expression class of each of a plurality of tumor cells included in the second tumor area.

16. The method of claim 11, wherein the determining comprises:
determining an analysis condition, based on at least one of user input, preset conditions, or metadata annotated on the pathological slide image; and
determining an evaluation criterion for determining the cell expression classes of the plurality of tumor cells, based on the analysis condition.

17. The method of claim 11, further comprising:
calculating a percentage of each of cell expression classes, based on a number of tumor cells corresponding to the cell expression class; and
predicting a patient's therapeutic responsiveness associated with the pathological slide image, based on the percentage.

18. The method of claim 11, wherein the generating comprises:
generating a plurality of cell images, based on positions of the plurality of detected tumor cells on the pathological slide image and the determined cell expression classes;
generating a plurality of layers corresponding to each of the cell expression classes by performing a convolution operation on the plurality of cell images; and
generating the heatmap image by overlaying the plurality of layers,
wherein the plurality of layers are normalized based on a reference layer corresponding to the plurality of tumor cells.

19. The method of claim 18, wherein the plurality of layers are expressed in different colors for each of the cell expression classes and with different transparencies according to a number of tumor cells corresponding to the cell expression classes.

20. A computer-readable recording medium having recorded thereon a program for causing a computer to perform the method of claim 11.
